(19) United States
(12) Patent Application Publication
(10) Pub. No.: US 2025/0375676 A1
(43) Pub. Date: Dec. 11, 2025

(54) FOLDABLE ELECTRIC GOLF TROLLEY

(71) Applicant: TED GOLF EQUIPMENT CO., LTD., Changzhou (CN)

(72) Inventors: Jiaxiong Gong, Changzhou (CN); Qian Gong, Changzhou (CN)

(73) Assignee: TED GOLF EQUIPMENT CO., LTD., Changzhou (CN)

(21) Appl. No.: 19/230,212

(22) Filed: Jun. 6, 2025

(30) Foreign Application Priority Data
Jun. 6, 2024 (CN) 2024107282267

(51) Int. Cl. A63B 55/60; B62B 3/02; B62B 5/00; B62B 5/04; B62B 5/06

(52) U.S. Cl. CPC A63B 55/61; B62B 3/022; B62B 5/004; B62B 5/04; B62B 5/064; B62B 5/067; A63B 2210/50; B62B 2005/0471

(57) ABSTRACT

The present disclosure relates to a foldable electric golf trolley. When the electric golf trolley is folded, connecting rods on two sides of a frame of the electric golf trolley and wheels connected to the connecting rods are folded on the two sides of the frame. When the electric golf trolley in the present disclosure is folded, two rear wheels and connecting rods used for connecting the frame and the rear wheels can be folded on the two sides of the frame, such that an entire size of the folded electric golf trolley is effectively reduced, and the electric golf trolley is smaller in occupation space and more convenient to move and store.

### TECHNICAL FIELD

The present disclosure belongs to the technical field of electric golf trolleys, and particularly relates to a foldable electric golf trolley.

### BACKGROUND OF THE INVENTION

Golf, a popular sport around the world, has officially become an Olympic competition event at the 31st Summer Olympics in 2016. The essence of the golf is to liberate people from age limitation and allow people to get in touch with nature, integrate with nature and fully enjoy the fun of the sport.

A golf trolley is used for carrying bags containing golf clubs and other items. An electric golf trolley powered by lithium batteries is capable of being driven electrically instead of manually, thus being more convenient and labor-saving to use.

In a case of the existing electric golf trolley, a power system for movement of a driver is mounted in a frame, and a drive shaft is drivingly connected to rear wheels on two sides of the frame. Since the drive shaft is used for transmitting torque, the drive shaft and the rear wheels connected to the drive shaft are unfoldable when the electric golf trolley is folded, which directly increases the size of the folded electric golf trolley and leads to larger occupation space.

### SUMMARY OF THE INVENTION

An objective of the present disclosure is to provide a foldable electric golf trolley, so as to solve the problem that an electric golf trolley occupies a large space after being folded.

The foldable electric golf trolley in the present disclosure is achieved as below.

According to the foldable electric golf trolley, when the electric golf trolley is folded, connecting rods on two sides of a frame of the electric golf trolley and wheels connected to the connecting rods are folded on the two sides of the frame.

Further, when a main tube assembly of the electric golf trolley is folded, the connecting rods on the two sides of the frame and the wheels connected to the connecting rods may be synchronously driven to be folded on the two sides of the frame.

Further, a lower main tube of the main tube assembly rotates forwards to be folded on the frame, and synchronously drives the connecting rods to rotate forwards to be folded on the two sides of the frame and the wheels connected to the connecting rods to be folded on outer sides of the corresponding connecting rods.

Further, the lower main tube is linked with the connecting rods through gears.

Further, bevel gears I are arranged on two sides of a lower end of the lower main tube respectively, bevel gears II meshing with the bevel gears I are arranged at one ends of the connecting rods towards the frame, and the other ends of the connecting rods are hinged to wheel assemblies connected to the connecting rods.

Further, a lower locking wrench is arranged on a rear side of the frame, locking plates rotatably fit in the frame are arranged on an inner side of the lower locking wrench, outer ring surfaces of the bevel gears I are provided with two locking nicks fit with the locking plates and corresponding to an unfolded state and a folded state of the electric golf trolley respectively, arc-shaped through holes are correspondingly arranged on the two locking plates, a transverse locking pin is arranged in the two arc-shaped through holes, and a locking bayonet fit with the locking pin is arranged at the lower end of the lower main tube; and

the locking pin is located in the locking bayonet, to lock an unfolded state or a folded state of the lower main tube.

Further, the lower main tube is provided with a pullable locking assembly, and the frame is provided with a locking hole fit with the pullable locking assembly;

a locking rod of the pullable locking assembly extends into the corresponding locking hole, to lock the unfolded state of the lower main tube;

a twistable locking assembly is arranged on a golf bag holder at an upper end of the lower main tube, and a locking slot is arranged at a front end of the frame; and

a locking block of the twistable locking assembly is snapped into the locking slot, to lock the folded state of the lower main tube.

Further, at least any one wheel of the electric golf trolley is internally provided with an intra-wheel power system for driving the electric golf trolley.

Further, the electric golf trolley is a four-wheel trolley or a three-wheel trolley.

Further, the electric golf trolley is a two-wheel trolley.

Further, the intra-wheel power system is mounted in at least one of wheels on two sides of a rear end of the frame; and

a box of the intra-wheel power system is hinged to the corresponding connecting rod.

Further, the intra-wheel power system is mounted in at least one of wheels at a front end of the frame; and

a box of the intra-wheel power system is connected to a corresponding front wheel frame.

Further, the intra-wheel power system includes an electric motor and a worm wheel meshing with an output worm of the electric motor, and a spindle of the worm wheel is connected to a wheel hub corresponding to the intra-wheel power system; and

the electric motor is a brushless motor.

Further, the intra-wheel power system includes an electric motor and a speed reduction assembly drivingly connected to the electric motor, and the speed reduction assembly is connected to an axle of a wheel corresponding to the intra-wheel power system; and

the speed reduction assembly includes a worm wheel meshing with an output worm of the electric motor, and a gear set transmitting torque of the worm wheel to the axle of the corresponding wheel.

Further, the intra-wheel power system further includes a parking assembly connected to an end of the output worm.

Further, the parking assembly includes a friction plate connected to the output worm, and a brake pad capable of locking the friction plate.

Further, the parking assembly further includes a brake stator, the brake pad is located on an inner side of the brake stator, the friction plate is mounted on one side of the brake stator towards the brake pad, and a coil is wound in the brake stator;

a return spring is mounted on one side of the brake stator towards the brake pad; and

a guide pin parallel to the output worm is mounted on the brake stator, and a guide nick fit with the guide pin is arranged on an outer ring surface of the brake pad.

Further, a battery mounting opening is arranged at a rear end of the frame of the electric golf trolley, and a battery of the electric golf trolley is mounted into a battery compartment in the frame from the battery mounting opening; and

a supporting wheel capable of horizontally retracting into a bottom of the frame is arranged on a rear side of the frame of the electric golf trolley.

Further, an ejection assembly capable of pushing the battery outwards from the battery mounting opening is arranged on a front side of the battery compartment.

Further, a golf bag holder of the electric golf trolley is provided with a detachable automatic following assembly.

By using the above technical solutions, the present disclosure has the following beneficial effects.

When the electric golf trolley in the present disclosure is folded, two rear wheels and connecting rods used for connecting the frame and the rear wheels can be folded on the two sides of the frame, such that an entire size of the folded electric golf trolley is effectively reduced, and the electric golf trolley is smaller in occupation space and more convenient to move and store.

### BRIEF DESCRIPTION OF DRAWINGS

The present disclosure will be further described below with reference to the accompanying drawings and examples.

FIG. 1 is an unfolded-state view of a foldable electric golf trolley according to Example 1 of the present disclosure;

FIG. 2 is a structural diagram of a fit portion between a lower main tube and a connecting rod of a foldable electric golf trolley according to Example 1 of the present disclosure;

FIG. 3 is a structural diagram of a fit portion between a lower main tube and a connecting rod of a foldable electric golf trolley according to Example 1 of the present disclosure;

FIG. 4 is an exploded view of a connection portion of an upper main tube and a lower main tube of a foldable electric golf trolley according to Example 1 of the present disclosure;

FIG. 5 is a structural diagram of an intra-wheel power system of a foldable electric golf trolley according to Example 1 of the present disclosure;

FIG. 6 is an exploded view of an intra-wheel power system of a foldable electric golf trolley according to Example 1 of the present disclosure;

FIG. 7 is a folded-state view of a foldable electric golf trolley according to Example 1 of the present disclosure;

FIG. 8 is an unfolded-state view of a foldable electric golf trolley according to Example 2 of the present disclosure;

FIG. 9 is a folded-state view of a foldable electric golf trolley according to Example 2 of the present disclosure;

FIG. 10 is a structural diagram of a lock portion between a lower main tube and a frame in an unfolded state in a foldable electric golf trolley according to Example 2 of the present disclosure;

FIG. 11 is a structural diagram of a lock portion between an upper main tube and a frame in a folded state in a foldable electric golf trolley according to Example 2 of the present disclosure;

FIG. 12 is a sectional view of an intra-wheel power system of a foldable electric golf trolley according to Example 3 of the present disclosure in an axial direction of an output worm;

FIG. 13 is an exploded view of an intra-wheel power system of a foldable electric golf trolley according to Example 3 of the present disclosure;

FIG. 14 is an unfolded-state view of a foldable electric golf trolley according to Example 4 of the present disclosure;

FIG. 15 is a folded-state view of a foldable electric golf trolley according to Example 4 of the present disclosure;

FIG. 16 is a sectional view of a foldable electric golf trolley according to Example 5 of the present disclosure in an unfolded state;

FIG. 17 is an unfolded-state view of a foldable electric golf trolley according to Example 6 of the present disclosure;

FIG. 18 is a structural diagram of an interior of an intra-wheel power system of a foldable electric golf trolley according to Example 6 of the present disclosure;

FIG. 19 is a structural diagram of an interior of an intra-wheel power system of a foldable electric golf trolley according to Example 7 of the present disclosure;

FIG. 20 is a sectional view of an electric motor of a foldable electric golf trolley according to Example 7 of the present disclosure in an axial direction of an output worm;

FIG. 21 is a structural diagram of a foldable electric golf trolley according to Example 8 of the present disclosure;

FIG. 22 is a structural diagram of a foldable electric golf trolley according to Example 9 of the present disclosure;

FIG. 23 is an unfolded-state view of a foldable electric golf trolley according to Example 10 of the present disclosure; and

FIG. 24 is a structural diagram of an automatic following assembly of a foldable electric golf trolley according to Example 10 of the present disclosure.

In the figures: rear wheel 1, frame 2, front wheel 3, front wheel frame 4, connecting rod 5, lower main tube 6, upper main tube 7, handle 8, bevel gear I 9, bevel gear II 10, intra-wheel power system 11, box 11-1, connecting groove 11-2, hinge rod 11-3, electric motor 11-4, worm wheel 11-5, output worm 11-6, spindle 11-7, bearing I 11-8, side sealing plate 11-9, bearing II 11-10, housing 11-11, heat dissipation cavity 11-12, heat dissipation window 11-13, friction plate 11-14, brake pad 11-15, pin hole 11-16, accommodating nick 11-17, brake stator 11-18, coil 11-19, annular groove bracket 11-20, return spring 11-21, guide pin 11-22, guide nick 11-23, main gear 11-24, auxiliary gear 11-25, auxiliary connecting rod 12, independent hinge seat 13, hinge plate I 14, hinge plate II 15, connecting shaft 16, lock block 17, lower locking wrench 18, cover plate 19, wrench limiting groove 20, axle 21, supporting leg 22, lower locking wrench 23, locking plate 24, locking nick 25, supporting wheel 26, triangular bracket 27, insertion hole 28, supporting wheel seat 29, supporting wheel frame 30, switch opening 31, battery switch 32, backing plate 33, arc-shaped through hole 34, locking pin 35, locking bayonet 36, pullable locking assembly 37, locking rod 37-1, pullable wrench 37-2, lower return spring 37-3, locking hole 38, mounting seat 39, golf bag holder 40, mounting table 40-1, threaded hole 40-2, positioning tooth groove 40-3, positioning step 40-4, auxiliary positioning hole 40-5, twistable locking assembly 41, locking block 41-1, locking wrench 41-2, upper return spring 41-3, push block 41-4, locking slot 42, bump 43, ejection assembly 44, ejection compartment 44-1, ejection sleeve 44-2, ejection spring 44-3, battery 45, battery locking block 45-1, upper shifting plate 45-2, automatic following assembly 46, following bracket 46-1, laser radar 46-2, positioning tooth 46-3, positioning groove 46-4, fixing bolt 47, rubber plug 48, and space D.

### DETAILED DESCRIPTION OF THE INVENTION

In order to make the objectives, technical solutions, and advantages in the embodiments of the present disclosure clearer, the technical solutions in the embodiments of the present disclosure are described clearly and completely below with reference to the accompanying drawings in the embodiments of the present disclosure. Apparently, the described embodiments are some embodiments rather than all embodiments of the present disclosure. All other embodiments derived by those of ordinary skill in the art based on the embodiments of the present disclosure without creative efforts fall within the scope of protection of the present disclosure.

Therefore, the following detailed description of the embodiments of the present disclosure provided in the accompanying drawings is not intended to limit the scope of the present disclosure claimed, and merely indicates the selected embodiments of the present disclosure. All other embodiments derived by those of ordinary skill in the art based on the embodiments of the present disclosure without creative efforts fall within the scope of protection of the present disclosure.

In the present application, rear wheels 1 refer to wheels located on two sides of a rear end of a frame 2. Wheels located at a front end of the frame 2 are front wheels 3. That is, a four-wheel trolley has two front wheels 3 and two rear wheels 1. A three-wheel trolley has one front wheel 3 and two rear wheels 1. A two-wheel trolley has two rear wheels 1.

Each rear wheel 1 is connected to the frame 2 through a connecting rod 5. Each front wheel 3 is connected to the frame 2 through a front wheel frame 4.

### Example 1

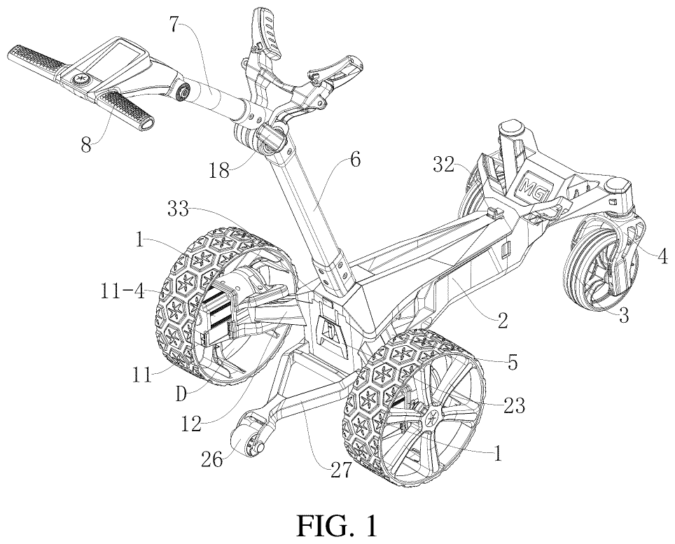

As shown in FIG. 1 to FIG. 7, according to a foldable electric golf trolley, when the electric golf trolley is folded, connecting rods 5 on two sides of a frame 2 of the electric golf trolley and wheels connected to the connecting rods 5 may be folded on the two sides of the frame 2.

In the example, the electric golf trolley is a four-wheel trolley.

Specifically, the four-wheel trolley includes a frame 2, two front wheels 3 mounted at a front end of the frame 2 through a front wheel frame 4, connecting rods 5 arranged on two sides of a rear end of the frame 2, rear wheels 1 arranged at outer ends of the connecting rods 5, a supporting wheel 26 arranged on a rear side of the frame 2, and a main tube assembly arranged on the frame 2. The main tube assembly includes a lower main tube 6, an upper main tube 7, and a handle 8 arranged at a top of the upper main tube 7.

In order to synchronously drive the connecting rods 5 on the two sides of the frame 2 and the wheels connected to the connecting rods 5 to be folded on the two sides of the frame 2 when the main tube assembly of the electric golf trolley is folded,

specifically, the lower main tube 6 of the main tube assembly rotates forwards to be folded on the frame 2, and synchronously drives the connecting rods 5 to rotate forwards to be folded on the two sides of the frame 2 and the wheels connected to the connecting rods 5 to be folded on outer sides of the corresponding connecting rods 5.

In the example, when the lower main tube 6 is folded, the connecting rods 5 connected to the rear wheels 1 rotate forwards to be folded on the two sides of the frame 2, and the two rear wheels 1 are folded on the outer sides of the connecting rods 5 connected to the rear wheels.

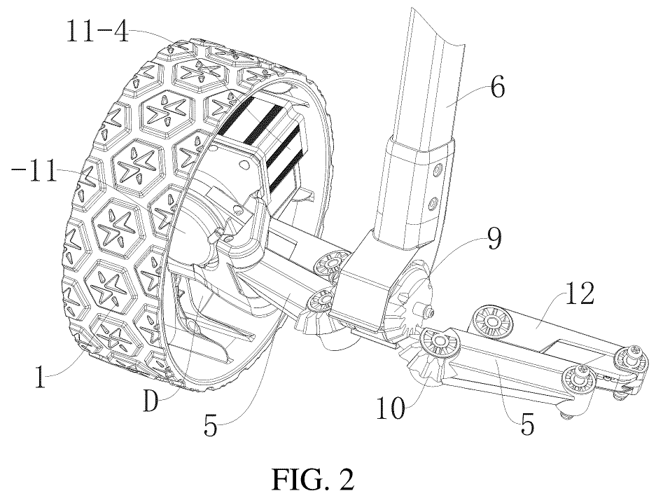

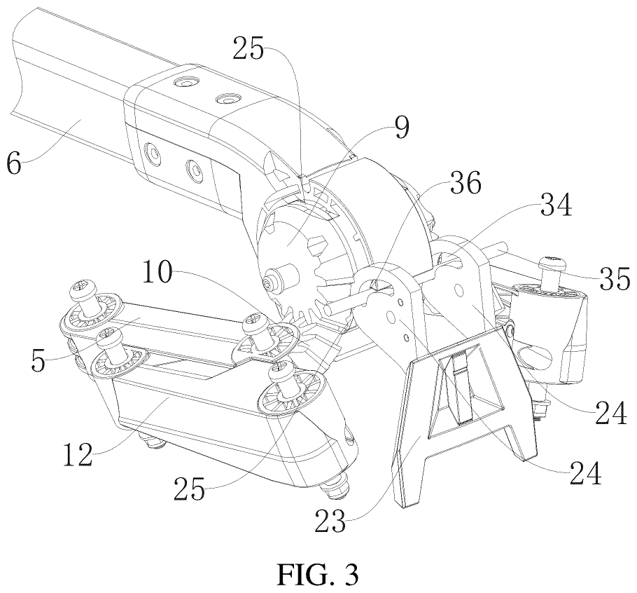

As shown in FIG. 2 to FIG. 3, in order to drive the connecting rods 5 to be folded through folding of the lower main tube 6, the lower main tube 6 is linked with the connecting rods 5 through gears.

Specifically, bevel gears I 9 are arranged on two sides of a lower end of the lower main tube 6 respectively. Bevel gears II 10 meshing with the bevel gears I 9 are arranged at one ends of the connecting rods 5 towards the frame 2. The other ends of the connecting rods 5 are hinged to wheel assemblies connected to the connecting rods.

As shown in FIG. 3, a lower locking wrench 23 is arranged on a rear side of the frame 2. Locking plates 24 rotatably fit in the frame are arranged on an inner side of the lower locking wrench 23. Outer ring surfaces of the bevel gears I 9 are provided with two locking nicks 25 fit with the locking plates 24 and corresponding to an unfolded state and a folded state of the electric golf trolley respectively.

Arc-shaped through holes 34 are correspondingly arranged on the two locking plates 24. A transverse locking pin 35 is arranged in the two arc-shaped through holes 34. A locking bayonet 36 fit with the locking pin 35 is arranged at the lower end of the lower main tube 6. When the electric golf trolley is in the folded state or the unfolded state, the locking pin 35 is located in the locking bayonet 36, so as to limit the lower main tube 6. Thus stability of the folded state or the unfolded state of the electric golf trolley is guaranteed.

When the electric golf trolley is operated to be unfolded or folded, a user operates the lower locking wrench 23 to rotate upwards to drive the locking plates 24 to be separated from the bevel gears I 9. At the same time, the locking plates 24 drive the locking pin 35 to move backwards to be disengaged from the locking bayonets 36. In this case, the electric golf trolley can be unfolded by rotating the lower main tube 6 upwards, or folded by rotating the lower main tube 6 downwards. When the lower main tube is rotated in place, the lower locking wrench 23 is rotated downwards. In this case, the locking plates 24 may be snapped in the corresponding locking nicks 25. The locking pin 35 may be snapped in the locking bayonets 36. Thus the lower main tube 6 is locked. The stability of the unfolded state or a folded state of the electric golf trolley can be guaranteed.

When the locking plates 24 are rotated, the locking pin 35 may be pushed to move by the arc-shaped through holes 34. Kidney-shaped holes are provided on the frame 2 outside the locking plates 24. Two ends of the locking pin 35 are fit in the kidney-shaped holes. The kidney-shaped holes guide movement of the locking pin.

When the electric golf trolley needs to be folded or unfolded, the user operates the lower locking wrench 23 to rotate upwards to drive the locking plates 24 to separate from the bevel gears I 9. In this case, the bevel gears I 9 may be rotated through the lower main tube 6, such that the lower main tube 6, the connecting rods 5 and the rear wheels 1 can be synchronously folded or unfolded. After they are folded or unfolded in place, the lower locking wrench 23 is rotated downwards. In this case, the locking plates 24 may be snapped in the corresponding locking nicks 25 to lock the bevel gears I 9, such that the lower main tube 6 cannot be rotated. The stability of the unfolded state or the folded state of the electric golf trolley is guaranteed.

A linkage structure between the lower main tube 6 and the connecting rods 5 is not limited to the above-mentioned bevel gear fitting manner.

In the example, the wheel assembly is a rear wheel assembly.

In order to drive the electric golf trolley, that is, a four-wheel trolley to move, at least any one wheel of the electric golf trolley is internally provided with an intra-wheel power system 11 for driving the electric golf trolley.

The intra-wheel power system 11 is mounted in at least any one wheel on the two sides of the rear end of the frame 2, that is, at least any one rear wheel 1.

The intra-wheel power system 11 means that a power system is mounted in a space D formed inside a corresponding wheel, but is not limited to such a manner that the power system is completely arranged in the space D, and may allow a small portion of the power system to extend beyond the space D formed by the wheel.

In the example, the intra-wheel power system 11 is mounted in each of the two rear wheels 1 of the four-wheel trolley. The rear wheel assembly includes the rear wheels 1 and the intra-wheel power systems 11 located in the rear wheels 1. Each intra-wheel power system 11 is located on an inner side of the corresponding rear wheel 1, that is, a side of the rear wheel 1 towards the frame 2.

Specifically, each intra-wheel power system 11 includes a box 11-1. A connecting groove 11-2 is arranged on an inner side of the box 11-1. The outer ends of the connecting rods 5 are hinged in the connecting grooves 11-2, such that when the four-wheel trolley is folded, the connecting rods 5 can conveniently drive the two rear wheels 1 to be folded.

Preferably, in order to guarantee stability of connection between the rear wheel assembly and the frame 2, two hinge rods 11-3 are arranged in each connecting groove 11-2. An auxiliary connecting rod 12 parallel to the connecting rod 5 is arranged on the rear side of the connecting rod. An outer end of the auxiliary connecting rod and an outer end of the connecting rod are hinged to the two hinge rods 11-3 in the connecting groove 11-2 correspondingly.

The bevel gear II 10 at an inner end of the connecting rod 5 is engaged with the bevel gear I 9 at a bottom of the lower main tube 6, and an inner end of the auxiliary connecting rod 12 is directly hinged to the frame 2.

The intra-wheel power system 11 may also be mounted on an outer side of the corresponding rear wheel 1, that is, a side of the rear wheel 1 facing away from the frame. In this case, the connecting rod 5 cannot be connected to the box 11-1. In this case, the rear wheel assembly further includes an independent hinge seat 13 arranged on the inner side of the rear wheel 1, so as to be hinged to the connecting rod 5 and the auxiliary connecting rod 12.

In the example, the upper main tube 7 and the lower main tube 6 are hinged to facilitate folding and unfolding of the upper main tube and the lower main tube.

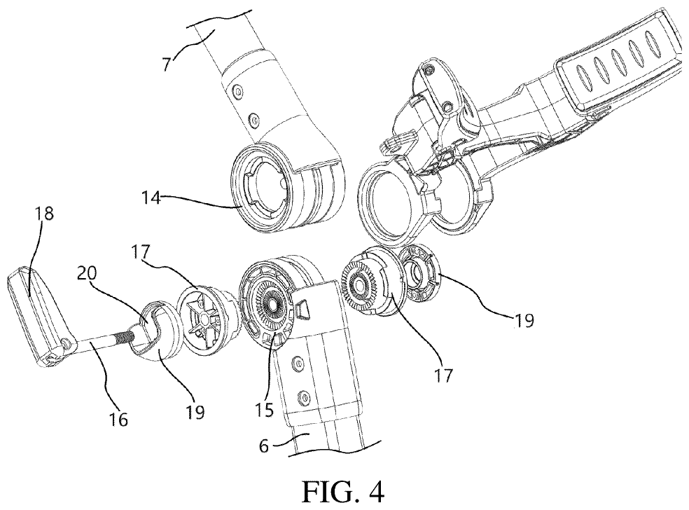

As shown in FIG. 4, specifically, a connector I at a lower end of the upper main tube 7 is provided with three hinge plates I 14 arranged in parallel. A connector II at an upper end of the lower main tube 6 is provided with two hinge plates II 15 arranged in parallel. The two hinge plates II 15 are respectively fit in gaps between two adjacent hinge plates I 14. A connecting shaft 16 penetrates centers, such that the hinge plates I 14 and the hinge plates II 15 can be rotatably fit on the connecting shaft 16.

Outer side surfaces of the two hinge plates I 14 located on the outer sides are provided with annular segmented slots. Lock blocks 17 with locking tooth surfaces on inner side surfaces are rotatably arranged in the slots. Due to arrangement of the slots, the lock blocks 17 cannot be rotated relative to the hinge plates I 14. Outer side surfaces of the hinge plates II 15 are provided with auxiliary tooth surfaces fit with the locking tooth surfaces. One end of the connecting shaft 16 is provided with a rotatable lower locking wrench 18. The other end of the connecting shaft is connected to the lock block 17 on the side through threads.

Cover plates 19 fixedly connected to the lock blocks 17 are respectively arranged on outer sides of the locking blocks. A wrench limiting groove 20 is arranged on a cover plate 19 on a side where the lower locking wrench 18 is located.

When the upper main tube 7 and the lower main tube 6 are folded, the lower locking wrench 18 is pulled to be located in an axial direction of the connecting shaft 16. The connecting shaft 16 is rotated by the lower locking wrench 18 to move towards the side where the lower locking wrench 18 is located. Thus the locking tooth surface on each lock block 17 is separated from a corresponding auxiliary tooth surface. Each hinge plate I 14 can be rotated relative to the hinge plate II 15. In this case, the upper main tube 7 may be rotated downwards around the top of the lower main tube 6 and folded on the rear side of the lower main tube 6. When the lower main tube 6 is folded forwards on the frame 2, the upper main tube 7 is located on the lower main tube 6. In a folding process of the lower main tube 6, the connecting rod 5 and the rear wheel 1 may be driven to be folded on the two sides of the frame 2, such that the entire electric golf trolley can be folded.

When the golf trolley is unfolded, the connecting shaft 16 is moved to one end away from the lower locking wrench 18. After the locking tooth surface meshes with the corresponding auxiliary tooth surface, the lower locking wrench 18 is pulled to be rotated to a direction perpendicular to the axial direction of the connecting shaft 16 and fit into the wrench limiting groove 20. In this case, a connection portion of the upper main tube 7 and the lower main tube 6 can be locked.

A folding method of the upper main tube 7 and the lower main tube 6 is not limited to the above. Other folding methods may also be used. For example, the upper main tube 7 is retracted into the lower main tube 6 in a telescopic manner.

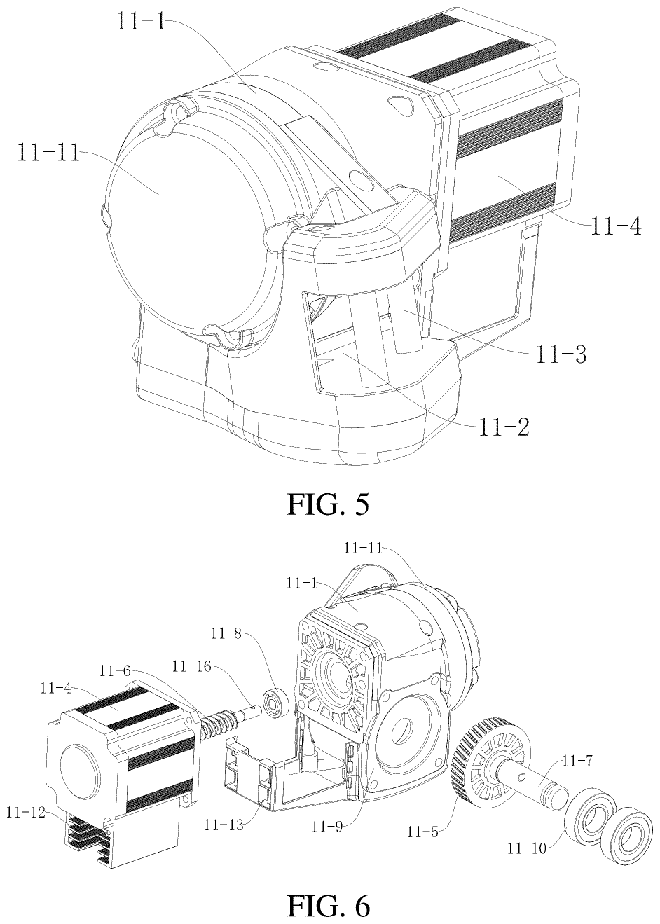

As shown in FIG. 5 to FIG. 6, in order to rotate the rear wheel 1 through the intra-wheel power system 11, the intra-wheel power system 11 includes an electric motor 11-4 and a worm wheel 11-5 meshing with an output worm 11-6 of the electric motor 11-4. A spindle 11-7 of the worm wheel 11-5 is connected to a wheel hub corresponding to the intra-wheel power system 11.

The electric motor 11-4 is a brushless motor.

Compared with a brush motor of same power, the brushless motor used in the present patent is smaller in size, such that a structure of the entire intra-wheel power system 11 is more compact, and the intra-wheel power system can be arranged in the wheel more conveniently.

In the example, the worm wheel 11-5 is mounted in the box 11-1 in order to protect a fit portion of the worm wheel 11-5 and the output worm 11-6. The spindle 11-7 of the worm wheel 11-5 penetrates out of one side of the box 11-1 and is directly connected to a corresponding hub of the rear wheel 1. The spindle 11-7 is fit with the box 11-1 through the bearing I 11-8. The box 11-1 on a side where the bearing I 11-8 is located is provided with a side sealing plate 11-9, which is connected to the box 11-1 through bolts. The worm wheel 11-5 and the bearing I 11-8 may be conveniently mounted by removing the side sealing plate 11-9.

In the example, the electric motor 11-4 is mounted on an upper rear side of the box 11-1 by bolts. A front end of the output worm 11-6 is fit with the box 11-1 through a bearing II 11-10.

A front side of the box 11-1 is provided with a housing 11-11 connected to the box through bolts. The bearing II 11-10 may be conveniently mounted by removing the housing 11-11.

Preferably, in order to achieve desirable heat dissipation of the electric motor 11-4, a heat dissipation cavity 11-12 is arranged outside the electric motor 11-4. A plurality of heat dissipation fins are arranged in the heat dissipation cavity 11-12. A heat dissipation window 11-13 is arranged on the box 11-1 to be fit with the heat dissipation cavity 11-12.

Specifically, the box 11-1 includes a cavity for accommodating the worm wheel 11-5, and a support seat located on a rear side of the cavity for supporting the electric motor 11-4. The electric motor 11-4 is mounted on the support seat. The heat dissipation window 11-13 is located on a rear wall of the support seat.

The intra-wheel power system 11 disclosed in the example may be provided without the heat dissipation cavity 11-12, or may be provided with the heat dissipation cavity 11-12.

The intra-wheel power system 11 of the example uses a transmission manner of the output worm 11-6 and the worm wheel 11-5. Not only the whole intra-wheel power system 11 can be connected to an electric control system of the electric golf trolley conveniently, so as to implement automatic control over a speed of the electric golf trolley, but also the intra-wheel power system 11 can have a self-locking function, so as to avoid occurrence of reverse rotation. Reliability of a transmission process is guaranteed. Safety of the electric golf trolley during driving is improved.

When the electric golf trolley is in a downhill process, the speed can also be limited. That is, a downhill speed is set. Thus no matter what slope gradient a slope is, the speed will not exceed the set speed. Accordingly, the safety of the electric golf trolley is guaranteed effectively.

Moreover, compared with a speed reduction assembly for ordinary gear transmission, a transmission speed reduction manner of a worm gear has more excellent self-locking performance. Thus the speed reduction assembly of the example has the following advantages:

First, once a transmission interface is powered off or has a mechanical failure, the speed reduction assembly (that is, cooperation of the worm gear) will produce self-locking, effectively preventing the reversal caused by accidental interference from the outside world.

Second, safety and reliability of mechanical transmission can be guaranteed. Once a failure occurs, transmission is stopped immediately, effectively avoiding damage to the electric motor 11-4 and other parts caused by mechanical damage.

Third, adjustment performance is desirable. Output torque can be adjusted by changing an angle between the worm wheel 11-5 and the output worm 11-6.

Moreover, compared with a hub motor, the intra-wheel power system 11 of the present disclosure has a small overall size and light weight, and uses the output worm 11-6 and the worm wheel 11-5 for cooperation. Thus operation noise is small. A reduction ratio is large. That is, a speed reduction function is desirable. Driving torque can be increased through deceleration, and then the electric golf trolley can easily cope with road conditions such as uphill.

The intra-wheel power system 11 used in the example is small in size and light in weight. Torque can be transmitted to the corresponding wheel only through fit between the output worm 11-6 and the worm wheel 11-5, that is, one-stage transmission. The structure is simple and compact, and a transmission effect is desirable.

Due to a rough terrain of a golf course, when the electric golf trolley tilts backwards and the front wheel 3 is suspended when the golf course is uphill, the supporting wheel 26 can support the electric golf trolley to ensure its stability.

In the example, the supporting wheel 26 is arranged on the rear side of the frame 2 through a triangular bracket 27. Two ends of the triangular bracket 27 are hinged to the two sides of the rear end of the frame 2. The supporting wheel 26 is mounted at a rear end of the triangular bracket 27.

In the example, a battery compartment of the electric golf trolley is located in the frame 2. A battery is a fire and explosion-proof battery. The battery is removed and mounted from above the frame 2.

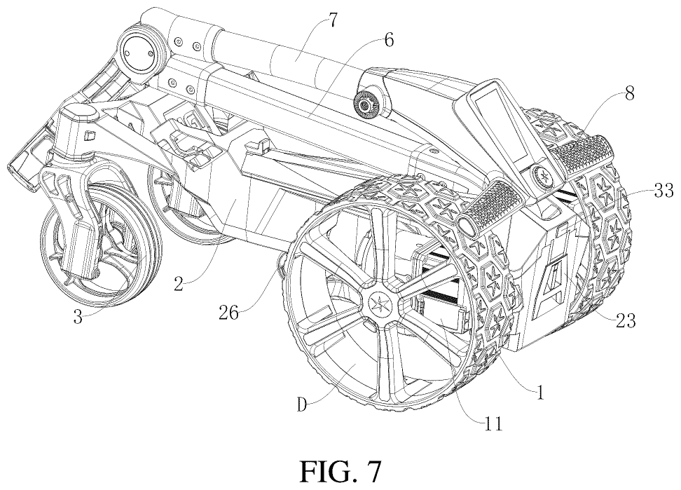

As shown in FIG. 7, when the four-wheel trolley of the example is folded, the upper main tube 7 is rotated backwards and downwards to be folded with the lower main tube 6. The lower main tube 6 is rotated forwards and downwards to be folded on the frame 2. When the lower main tube 6 is folded, the connecting rods 5 are driven by the lower main tube 6 to rotate forwards, so as to drive the rear wheels 1 connected to the connecting rods to be folded on the two sides of the frame 2. That is, the connecting rods 5 and the corresponding rear wheels 1 are attached to the side surfaces of the frame 2. The triangular bracket 27 is rotated downwards and forwards to drive the supporting wheel 26 to fold under the frame 2. Such a folding method can effectively reduce the size of the folded four-wheel trolley, which is more convenient to move and store.

In the example, the rear side of the frame 2 is provided with a backing plate 33, which may be fit with the two rear wheels 1. After the electric golf trolley is folded, the electric golf trolley is placed in a vertical manner. That is, the backing plate 33 and the two rear wheels 1 form a triangular support, so as to guarantee the stability of the electric golf trolley.

In the example, each of the two rear wheels 1 of the four-wheel trolley is provided with the intra-wheel power system 11. Moreover, the intra-wheel power system 11 also has the following configuration manners:
(1) the intra-wheel power system 11 is mounted in the rear wheel 1 on one side;
(2) the intra-wheel power system 11 is mounted in the front wheel 3 on one side or two sides;
(3) the intra-wheel power system 11 is mounted in the front wheel 3 on one side and the rear wheel 1 on one side (the front wheel and the rear wheel 1 on a same side or the front wheel and the rear wheel 1 on the same side);
(4) the intra-wheel power system 11 is mounted in the front wheel 3 on one side and the rear wheels 1 on two sides, or the front wheels 3 on two sides and the rear wheel 1 on one side; and
(5) the intra-wheel power system 11 is mounted in the front wheels 3 on two sides and the rear wheels 1 on two sides.

### Example 2

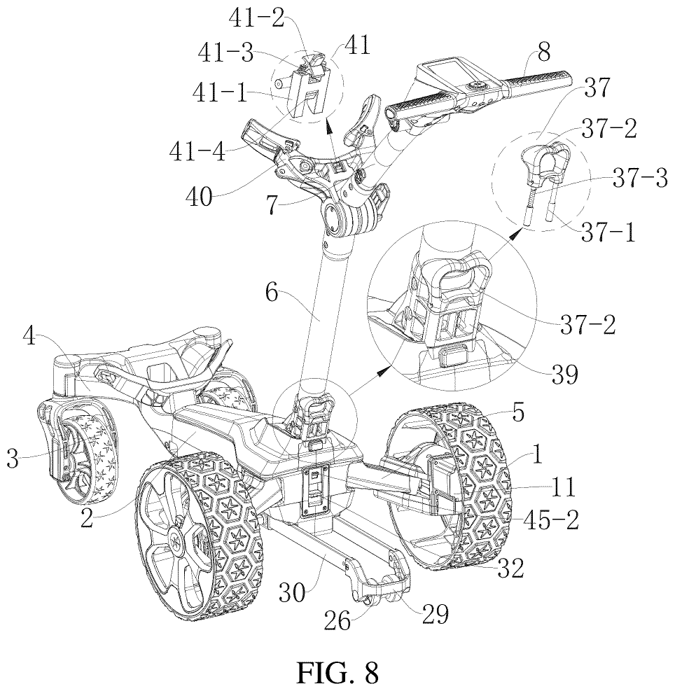

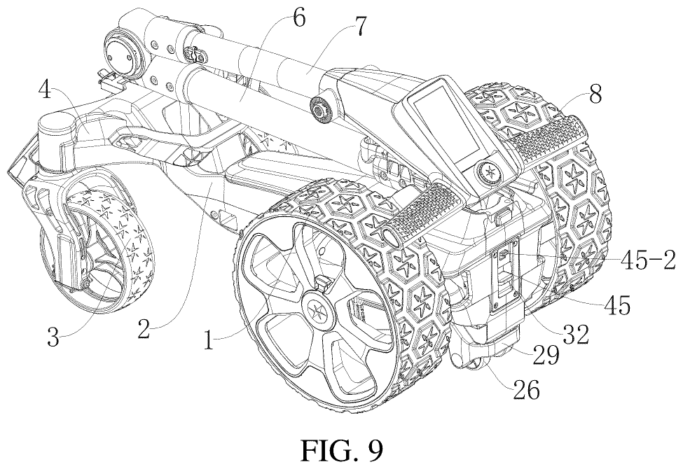

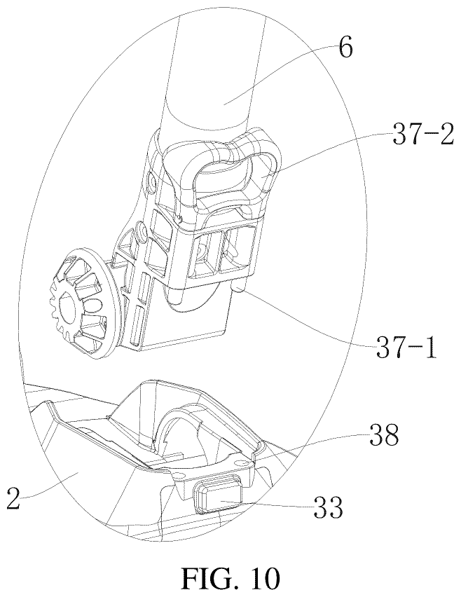

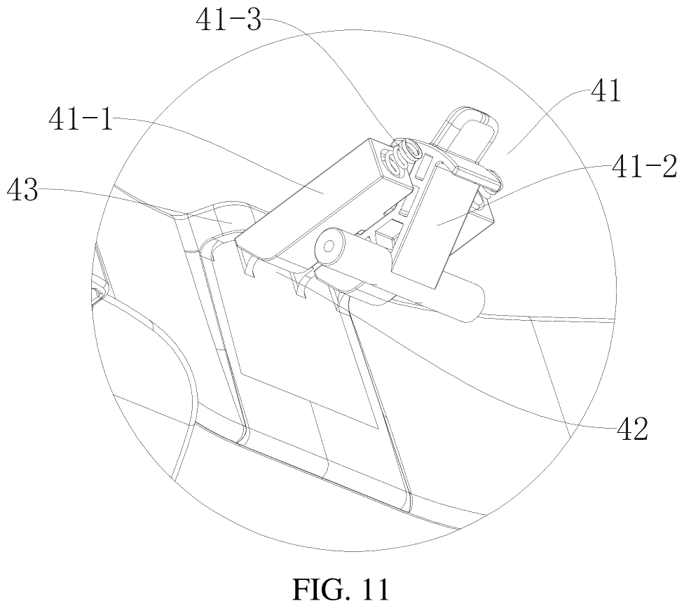

As shown in FIG. 8 to FIG. 11, on the basis of Example 1, the example further provides a foldable electric golf trolley, which has a same general structure as that of the above example. A difference from Example 1 lies in a locking manner of folding and unfolding between the lower main tube 6 and the frame 2 of the electric golf trolley. Specifically,

In the example, in order to lock the unfolding of the lower main tube 6, a pullable locking assembly 37 is mounted on the lower main tube 6. A locking hole 38 fit with the pullable locking assembly 37 is formed in the frame 2. A locking rod 37-1 of the pullable locking assembly 37 extends into a corresponding locking hole 38, to lock an unfolded state of the lower main tube 6.

The pullable locking assembly 37 includes a pullable wrench 37-2 and a locking rod 37-1 connected to the pullable wrench 37-2 and located at a bottom of the pullable wrench 37-2. The locking rod 37-1 is provided with a lower return spring 37-3. A lower end of the locking rod 37-1 may extend into the corresponding locking hole 38.

Specifically, a mounting seat 39 is arranged at a cooperation position between a lower end of the lower main tube 6 and the frame 2. The pullable wrench 37-2 and the locking rod 37-1 are mounted on the mounting seat 39. The lower return spring 37-3 is located in the mounting seat 39. A lower end of the locking rod 37-1 protrudes from a bottom of the mounting seat 39.

In a process of rotating and unfolding the lower main tube 6, a plane where the locking hole 38 is located presses the locking rod 37-1 upwards, and then compresses the lower return spring 37-3 until the locking rod 37-1 is opposite the corresponding locking hole 38. In this case, the locking rod 37-1 extends into the corresponding locking hole 38 under an elastic force of the lower return spring 37-3, so as to lock the lower main tube 6, and thus the lower main tube cannot be folded. In a case that the lower main tube 6 needs to be folded, only the pullable wrench 37-2 needs to be pulled upwards. The locking rod 37-1 moves upwards along with the pullable wrench 37-2 (this process compresses the lower return spring 37-3). Then the locking rod 37-1 can withdraw from the corresponding locking hole 38. In this case, the lower main tube 6 can be unlocked to be rotated and folded.

In order to lock the folded state of the lower main tube 6, a twistable locking assembly 41 is arranged on a golf bag holder 40 at an upper end of the lower main tube 6. A locking slot 42 is arranged at a front end of the frame 2. A locking block 41-1 of the twistable locking assembly 41 is snapped into the locking slot 42, to lock the folded state of the lower main tube 6.

The twistable locking assembly 41 includes a locking wrench 41-2 hinged to the golf bag holder 40, the locking block 41-1 fit with the locking wrench 41-2, and an upper return spring 41-3 mounted on a top of the locking block 41-1.

Specifically, the locking block 41-1 has an H-shaped structure. A push block 41-4 on a rear side of the locking wrench 41-2 is snapped in a notch at a bottom of the locking block 41-1. A lower end of the locking block 41-1 may be driven to rotate forwards and upwards by shifting the locking wrench 41-2 forwards. A front end of the frame 2 is provided with a forward bump 43. The locking slot 42 is located at a bottom of the bump 43.

In a process of rotating and folding the lower main tube 6, the locking block 41-1 moves upwards under push of the bump 43 and compresses the upper return spring 41-3 until the locking block 41-1 is rotated to a front side of the bump 43. In this case, the locking block 41-1 is snapped in the locking slot 42 at the bottom of the bump 43 under an elastic force of the upper return spring 41-3. Thus the lower main tube 6 can be locked and cannot be unfolded. In a case that the lower main tube 6 needs to be unfolded, only an upper end of the locking wrench 41-2 needs to be shifted, and then the push block 41-4 of the locking wrench 41-2 pushes a lower end of the locking block 41-1 to move forwards and upwards (this process compresses the upper return spring 41-3). Thus the locking block is separated from the locking slot 42. In this case, the lower main tube 6 can be unlocked to be rotated and unfolded.

Preferably, in order to facilitate the cooperation of the locking block 41-1 with the locking slot 42 in a rotation and folding process of the lower main tube 6, a lower end of the locking block 41-1 is in a shape of an inclined plane with a high front and a thick bottom.

The unfolding and locking manners disclosed in the example have simple structures and convenient operation.

As can be seen from a linkage manner of the rear wheel 1 and the lower main tube 6 in Example 1, when the lower main tube 6 is unfolded, the rear wheel 1 may be unfolded simultaneously by the connecting rod 5. Similarly, when the lower main tube 6 is folded, the rear wheel 1 can be folded simultaneously by the connecting rod 5. Accordingly, in the example, the folded state or the unfolded state of the rear wheel 1 is locked simultaneously while the folded state or the unfolded state of the lower main tube 6 is locked. Moreover, the folded state or the unfolded state between the lower main tube 6 and the upper main tube 7 is locked in the manner described in Example 1.

Furthermore, the electric golf trolley of the example uses a structure of the supporting wheel 26 and an assembling method of a battery 45 in Example 5.

### Example 3

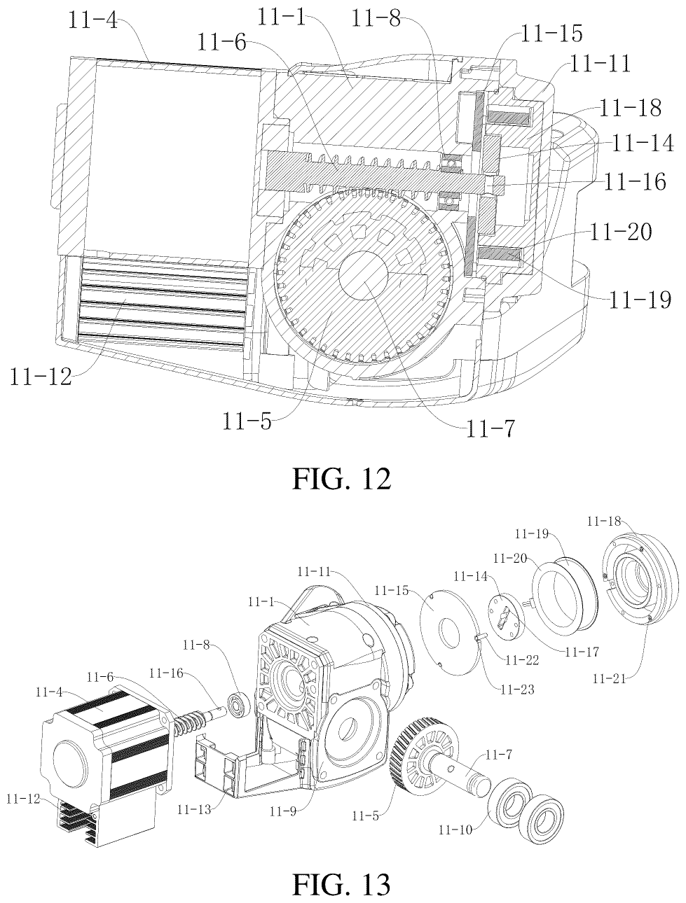

As shown in FIG. 12 to FIG. 13, on the basis of Example 1, the example further provides a foldable electric golf trolley, which has a same general structure as that of Example 1. A difference lies in that:

In order to improve a parking function of an intra-wheel power system 11 and guarantee safety of the electric golf trolley when parking, the intra-wheel power system 11 further includes a parking assembly connected to an end of the output worm 11-6.

In order to achieve a parking effect, the parking assembly includes a friction plate 11-14 connected to the output worm 11-6, and a brake pad 11-15 capable of locking the friction plate 11-14.

When the electric golf trolley is driven, the output worm 11-6 may drive the friction plate 11-14 to rotate synchronously. During parking, the brake pad 11-15 moves towards the friction plate 11-14 and may lock the friction plate 11-14 to prevent the friction plate from rotating. Thus the output worm 11-6 cannot be rotated, and a purpose of parking is achieved.

Specifically, in order to connect the output worm 11-6 to the friction plate 11-14, a pin hole 11-16 is arranged on the output worm 11-6. The friction plate 11-14 is connected to the output worm 11-6 through a pin (not shown) mounted in the pin hole 11-16.

A periphery of an inner hole of the friction plate 11-14 is provided with two accommodating nicks 11-17 that are in communication with the friction plate and are symmetrically arranged. When the output worm 11-6 equipped with the pin is fit in the inner hole of the friction plate 11-14, two ends of the pin are located in the two accommodating nicks 11-17. When the output worm 11-6 is rotated, the pin can be used for driving the friction plate 11-14 to rotate synchronously.

In order to drive the brake pad 11-15 to lock the friction plate 11-14, the parking assembly further includes a brake stator 11-18. The brake pad 11-15 is located on an inner side of the brake stator 11-18. The friction plate 11-14 is mounted on one side of the brake stator 11-18 towards the brake pad 11-15. A coil 11-19 is wound in the brake stator 11-18.

Specifically, an annular cavity is provided in the brake stator 11-18. An annular groove bracket 11-20 with an outward opening is provided in the annular cavity. The coil 11-19 is wound in the annular groove bracket 11-20.

One end of an inner hole of the brake stator 11-18 towards the brake pad 11-15 is provided with a mounting cavity with an inner diameter greater than a diameter of the inner hole. The friction plate 11-14 is arranged in the mounting cavity.

The coil 11-19 is energized. The brake stator 11-18 becomes a magnet with a magnetic force and attracts the brake pad 11-15. Then the friction plate 11-14 is clamped between the brake pad 11-15 and the brake stator 11-18. Rotation of the friction plate 11-14 and the output worm 11-6 is prevented.

Preferably, an outer ring surface of the brake stator 11-18 is provided with a wire passing notch, such that an end of the coil 11-19 can be led out and connected to a power supply.

In order to achieve inward return of the brake pad 11-15 when parking is released, a return spring 11-21 is mounted on one side of the brake stator 11-18 towards the brake pad 11-15.

Specifically, a side surface of the brake stator 11-18 towards the brake pad 11-15 is provided with a mounting hole I. The return spring 11-21 is arranged in the mounting hole I.

When the coil 11-19 is energized, and the brake pad 11-15 moves towards the brake stator 11-18 to clamp the friction plate 11-14, the return spring 11-21 is compressed. After the coil 11-19 is de-energized, the brake stator 11-18 loses the magnetic force, and the brake pad 11-15 moves inwards under an elastic force of the return spring 11-21, that is, moves away from the brake stator 11-18 to return, such that a parking state can be released.

In order to guide movement of the brake pad 11-15, a guide pin 11-22 parallel to the output worm 11-6 is mounted on the brake stator 11-18. A guide nick 11-23 fit with the guide pin 11-22 is arranged on an outer ring surface of the brake pad 11-15.

Specifically, a mounting hole II is provided on one side of the brake stator 11-18 towards the brake pad 11-15. The guide pin 11-22 is mounted in the mounting hole II. The guide pin 11-22 can guide the brake pad when the brake pad 11-15 moves, that is, in a parking state or a parking release state.

Moreover, the guide pin 11-22 can also limit the brake pad 11-15 in a circumferential direction, so as to prevent the brake pad from following the friction plate 11-14 and so on to rotate freely.

In the example, the parking assembly is arranged at one end of the box 11-1 facing away from the electric motor 11-4, that is, a front end of a cavity of the box 11-1. The output worm 11-6 is fit with the worm wheel 11-5. An end of the output worm away from the electric motor 11-4, that is, a front end, is connected to the parking assembly. The front end is connected to the friction plate 11-14 after passing through the brake pad 11-15.

When the parking assembly is fit with the electric motor 11-4, the parking assembly can be mounted by removing a housing 11-11. The housing 11-11 can protect the parking assembly well.

The parking assembly is not limited to being mounted on the front end of the output worm 11-6, but it can also be mounted on a rear end of the electric motor 11-4 (in a manner similar to that in Example 6), so as to be fit with a rear end of the output worm 11-6. The parking effect can also be achieved.

The folding manner and the folding process of the four-wheel trolley disclosed in the example are the same as those of the four-wheel trolley in Example 1.

### Example 4

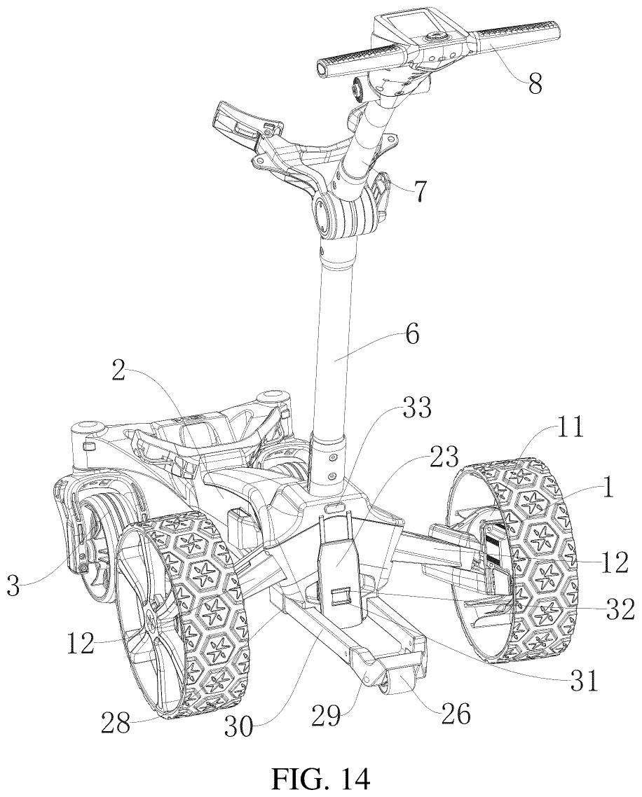

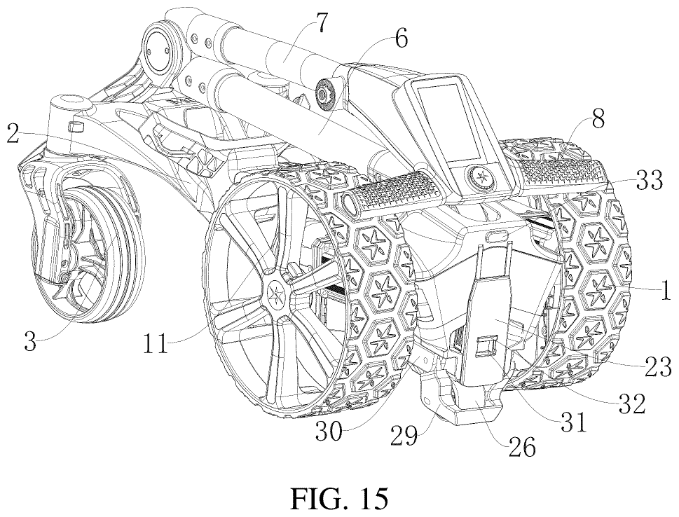

As shown in FIG. 14 to FIG. 15, on the basis of Example 1, the example further provides a foldable electric golf trolley, which has a same general structure as that of Example 1. A difference lies in that:

A battery mounting opening is arranged at a rear end of the frame 2 of the electric golf trolley. A battery 45 of the electric golf trolley is mounted into a battery compartment in the frame 2 from the battery mounting opening.

In Example 1, the battery 45 is mounted in the battery compartment from the top of the frame 2. But after the electric golf trolley is folded, the battery 45 cannot be removed and mounted. Thus use is very inconvenient. In order to solve the problem, the example provides an electric golf trolley equipped with the battery 45 from the rear end of the frame 2.

Specifically, a position where the lower locking wrench 23 is located is a battery mounting opening. After the lower locking wrench 23 is rotated upwards to be opened, the battery 45 in the battery compartment can be removed, or the battery 45 can be mounted into the battery compartment. Even if the electric golf trolley is in the folded state, the battery 45 can still be removed and mounted. Thus use is more convenient and simple.

In order to further reduce the size of the electric golf trolley during folding, in the example, a supporting wheel 26 capable of horizontally retracting into a bottom of the frame 2 is arranged on a rear side of the frame 2 of the electric golf trolley.

Specifically, two insertion holes 28 are provided at the bottom of the frame 2. The supporting wheel 26 is mounted on a supporting wheel seat 29. The supporting wheel seat 29 is rotatably assembled on two supporting wheel frames 30 arranged in parallel. The supporting wheel frames 30 are correspondingly assembled in the two insertion holes 28.

The folding manner and folding process of the four-wheel trolley disclosed in the example are the same as those of the four-wheel trolley in Example 1 approximately. A difference is only a folding process at the support wheel 26. That is, when the electric golf trolley is folded, the supporting wheel seat 29 is rotated downwards, and the supporting wheel frame 30 is pushed forwards, such that the supporting wheel 26, the supporting wheel seat 29 and the supporting wheel frame 30 are all located at the bottom of the frame 2.

When the electric golf trolley is in use, the supporting wheel seat 29 is rotated to a position at a same height as the supporting wheel frame 30, so as to be fit with the rear wheel 1 and the front wheel 3 to support the electric golf trolley.

To mount or remove the battery 45 in the unfolded state, the supporting wheel seat 29 needs to be rotated downwards, and then the lower locking wrench 23 is rotated upwards. Thus the battery mounting opening can be opened. In this case, the battery 45 can be inserted or withdrawn. Moreover, in this process, the supporting wheel frame 30 can guide and support insertion or withdrawing of the battery 45.

When the battery 45 is removed and mounted in the folded state, since the supporting wheel 26 is located at the bottom of the frame 2, the lower locking wrench 23 can be rotated upwards to open the battery mounting opening, and the battery 45 can be removed and mounted.

Preferably, in order to switch on and off the battery 45 conveniently, in the example, the lower locking wrench 23 is provided with a switch opening 31 through which a switch 32 of the battery 45 can pass.

### Example 5

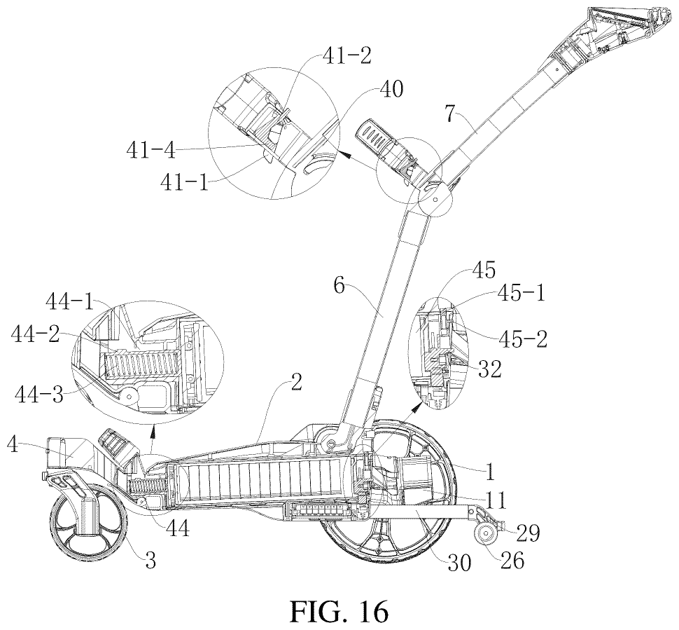

As shown in FIG. 16, on the basis of Example 4, the example further provides a foldable electric golf trolley. A difference lies in that:

An ejection assembly 44 capable of pushing the battery 45 outwards from the battery mounting opening is arranged on a front side of the battery compartment.

The ejection assembly 44 includes an ejection compartment 44-1 arranged at a front side of the battery compartment. An ejection sleeve 44-2 having an opening at a front end is arranged in the ejection compartment 44-1. An ejection spring 44-3 is arranged in the ejection sleeve 44-2.

The battery 45 is mounted in the battery compartment in a manner that a front is lower than a rear. A rear end of the battery 45 is provided with a battery locking block 45-1 protruding from a top of the battery 45. The battery locking block 45-1 is provided with an upper shifting plate 45-2 protruding from a rear end surface of the battery 45. A top of the rear end of the battery compartment is provided with a locking hole 38 of the battery 45 that is fit with the battery locking block 45-1. A bottom of the battery locking block 45-1 is provided with a locking spring (not shown in the figure).

In the example, locking of folding and unfolding of the lower main tube 6 uses the method in Example 2, such that no structure of the lower locking wrench 23 is provided. The rear end of the battery compartment, that is, the battery mounting opening, is in an open state. No shielding by the lower locking wrench 23 exists in Example 4.

When the battery 45 is mounted in the battery compartment, the battery locking block 45-1 protrudes into the locking hole 38 of the battery 45 under the action of the locking spring at the bottom, and the ejection spring 44-3 is in a compressed state. When the battery 45 needs to be removed, the upper shifting plate 45-2 on the battery locking block 45-1 is shifted downwards, such that the battery locking block 45-1 withdraws from the locking hole 38 of the battery 45. In this case, the battery 45 can be pushed backwards by the ejection sleeve 44-2 under an elastic force of the ejection spring 44-3 on the battery 45. The battery 45 can protrude out of the battery mounting opening. In this case, the battery 45 can be quickly and simply removed from the battery compartment.

Moreover, a battery switch 32, on a power connector of the battery 45, for starting or stopping an energizing state between the battery 45 and the electric golf trolley protrudes from the rear end of the battery 45. When the battery 45 energizes the electric golf trolley, the power connector is connected to a trolley connector at a bottom of the battery 45. In a case that the battery 45 is to be removed, the battery switch 32 needs to be shifted upwards in advance to move up the power connector of the battery 45 and separate the power connector from the golf trolley connector. Then the battery 45 can be removed. In this way, no damage to the power connector is caused, and the battery 45 can be removed in a power-off state with desirable safety.

In the example, since the battery 45 is designed to be inclined with the front lower than the rear, the supporting wheel 26 does not interfere with the battery when the battery is removed. Accordingly, the supporting wheel seat 29 in the example is directly fixed to a rear end of the supporting wheel frame 30. No rotating design is needed. The supporting wheel seat 29 does not need to be rotated downwards when the battery 45 is removed. Correspondingly, when the electric golf trolley is folded, only the supporting wheel frame 30 needs to move forwards to be retracted into the bottom of the frame 2. The operation is simpler.

Preferably, positioning holes are provided on outer side surfaces of at least one supporting wheel frame 30 near a front end and a rear end. A positioning screw is arranged on the frame 2. When the supporting wheel 26 is pulled out in place, the positioning screw can be automatically ejected into the positioning hole of the support wheel frame 30 near the front end, so as to lock the supporting wheel 26 and prevent it from moving forwards randomly. Similarly, when the supporting wheel 26 moves forwards to be retracted into the bottom of the frame 2, the positioning screw is automatically ejected into the positioning hole of the support wheel frame 30 near the rear end, so as to lock the supporting wheel 26 and prevent the supporting wheel from moving backwards randomly.

### Example 6

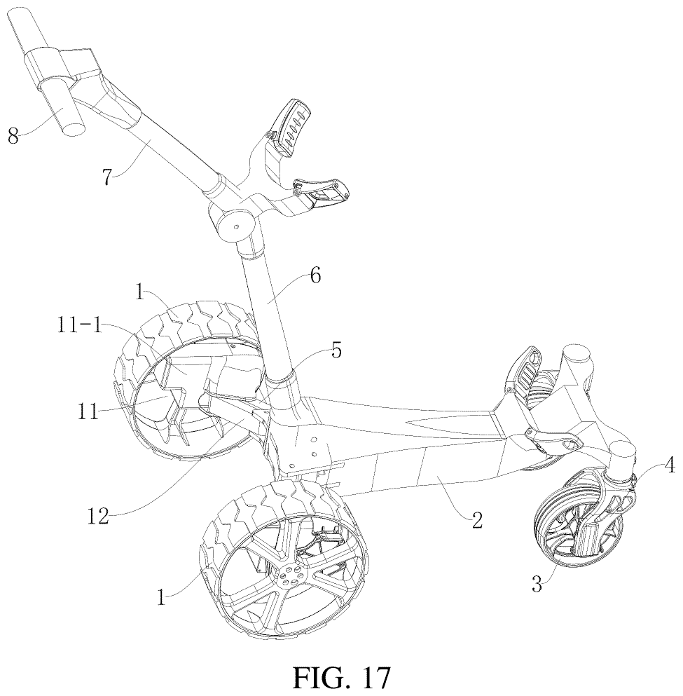

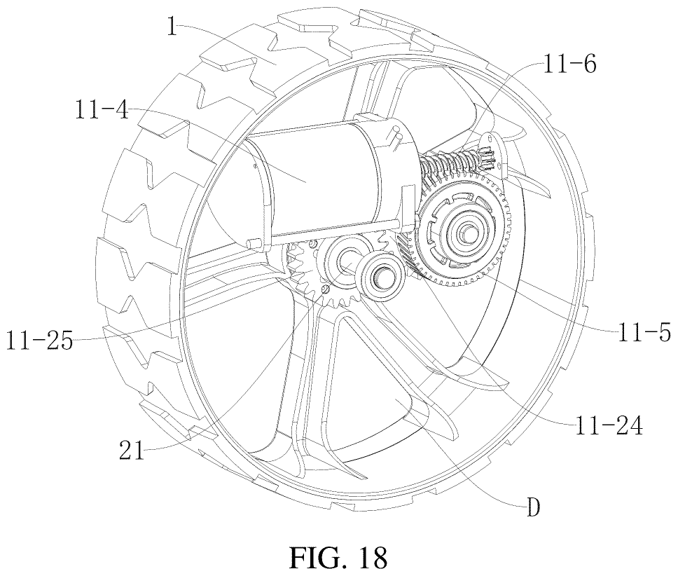

As shown in FIG. 17 to FIG. 18, on the basis of Example 1, the example further provides a foldable electric golf trolley. The electric golf trolley is also a four-wheel golf trolley. Two rear wheels 1 of the four-wheel golf trolley are each internally provided with an intra-wheel power system 11.

A difference lies in that the intra-wheel power system 11 in the example uses another structure.

Specifically, the intra-wheel power system 11 includes an electric motor 11-4 and a speed reduction assembly drivingly connected to the electric motor 11-4. The speed reduction assembly is connected to an axle 21 (that is, an axle 21 of the rear wheel 1 in the example) of a wheel corresponding to the intra-wheel power system 11.

In the example, the electric motor 11-4 and the speed reduction assembly are arranged in the box 11-1. The electric motor 11-4 is fixedly connected to the box 11-1.

In the example, a hinge manner of the connecting rod 5 and the intra-wheel power system 11 is not limited to that the connecting rod 5 is hinged to the box 11-1. In a case where no box 11-1 is provided, the connecting rod 5 may be directly connected to the electric motor 11-4 through a corresponding hinge structure. An effect that the connecting rod 5 and the rear wheel 1 can follow to be folded in the folding process of the golf trolley can also be achieved.

Specifically, the speed reduction assembly includes a worm wheel 11-5 meshing with an output worm 11-6 of the electric motor 11-4, and a gear set transmitting torque of the worm wheel 11-5 to the axle 21 of the corresponding wheel.

In the example, on the basis of Example 1, a set of gear transmission is added to the intra-wheel power system 11, that is, torque of the worm wheel 11-5 can be transmitted to the axle 21 of the corresponding wheel only through a gear set.

Through arrangement of the gear set, the electric motor 11-4 can be offset mounted, such that a structure of the entire intra-wheel power system 11 is more compact, and an application range of electric motor types can also be expanded.

In the example, the gear set includes a main gear 11-24 and an auxiliary gear 11-25 meshing with each other. The main gear 11-24 and the worm wheel 11-5 are coaxially arranged. The auxiliary gear 11-25 is mounted on the axle 21 to the corresponding rear wheel 1.

During transmission, the output worm 11-6 of the electric motor 11-4 drives the worm wheel 11-5 to rotate. The main gear 11-24 and the worm wheel 11-5 are rotated synchronously. The auxiliary gear 11-25 is driven by the main gear 11-24 to rotate, so as to drive the axle 21 and the corresponding rear wheel 1 to rotate.

The folding manner and the folding process of the four-wheel trolley disclosed in the example are the same as those of the four-wheel trolley in Example 1.

### Example 7

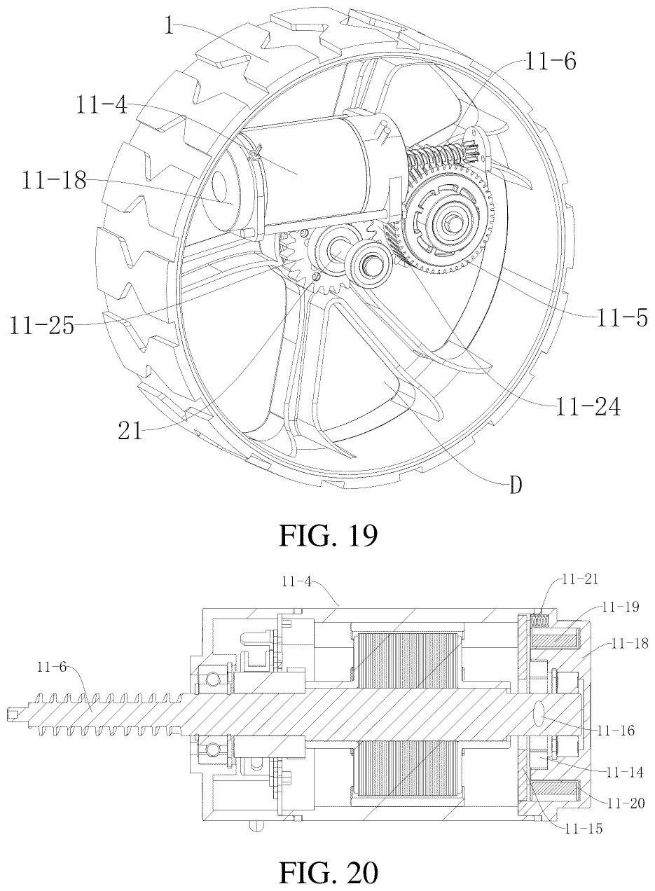

As shown in FIG. 19 to FIG. 20, on the basis of Example 6, the example further provides a foldable electric golf trolley, which has a same structure as that of Example 6 approximately. A difference lies in that:

The intra-wheel power system 11 further includes a parking assembly. That is, the parking assembly is added to the intra-wheel power system 11 in Example 6.

In the example, the parking assembly is located at a rear of the electric motor 11-4. A structure, a manner of connection to the output worm 11-6, and a working principle of the parking assembly are the same as those of the parking assembly in Example 3.

The folding manner and the folding process of the four-wheel trolley disclosed in the example are the same as those of the four-wheel trolley in Example 1.

### Example 8

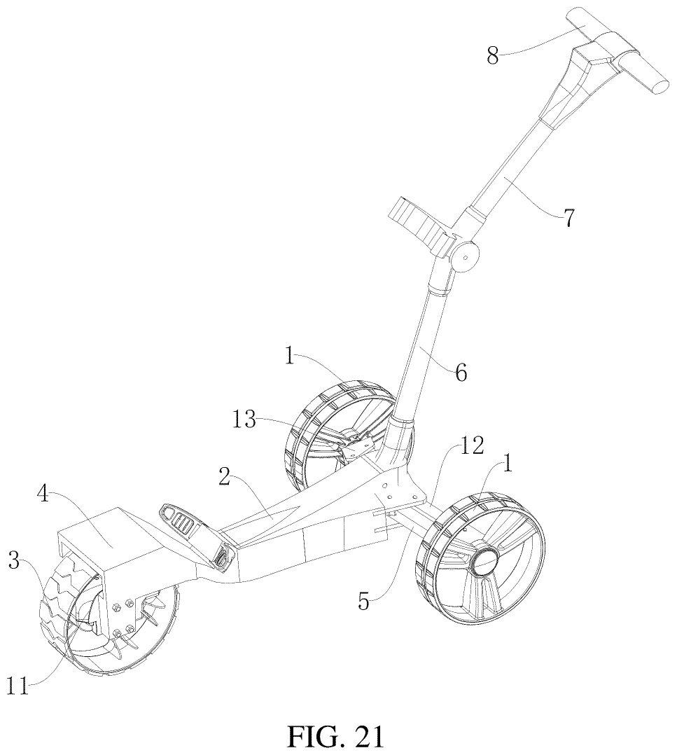

As shown in FIG. 21, on the basis of Example 6, the example further provides a foldable electric golf trolley. The electric golf trolley is a three-wheel golf trolley. An intra-wheel power system 11 is mounted in a front wheel 3 of the electric golf trolley.

The intra-wheel power system 11 of the example uses the structure of Example 6.

The intra-wheel power system 11 may be mounted on either side of the front wheel 3. A box 11-1 is connected to a front wheel frame 4 of the front wheel 3.

In the example, the front wheel frame 4 has a U-shaped structure with a downward opening. A lower end of the front wheel frame 4 is fixedly connected to the box 11-1 on a side where the intra-wheel power system 11 is located.

The three-wheel trolley is similar to the four-wheel trolley in structure, and differs in that only one front wheel 3 is arranged on a front side of the frame 2 of the three-wheel trolley.

In the example, an independent hinge seat 13 rotatably fit with the rear wheel 1 is arranged on an inner side of the rear wheel 1 of the three-wheel trolley. Outer ends of the connecting rod 5 and the auxiliary connecting rod 12 are hinged to the independent hinge seat 13. Thus the connecting rod 5 and the rear wheel 1 can be folded in a same manner as the four-wheel trolley in Example 1.

The example uses the intra-wheel power system 11 disclosed in Example 6.

For the three-wheel trolley, the intra-wheel power system 11 can be mounted in the front wheel 3. Besides, the intra-wheel power system 11 has the following arrangement methods:
(1) the intra-wheel power system is only mounted in the rear wheel 1, that is, mounted in the rear wheel 1 on one side, or the rear wheels 1 on two sides; and
(2) the intra-wheel power system is mounted in the front wheel 3 and the rear wheel 1, that is, mounted in the front wheel 3 and the rear wheel 1 on one side, or the front wheel 3 and the rear wheels 1 on two sides.

### Example 9

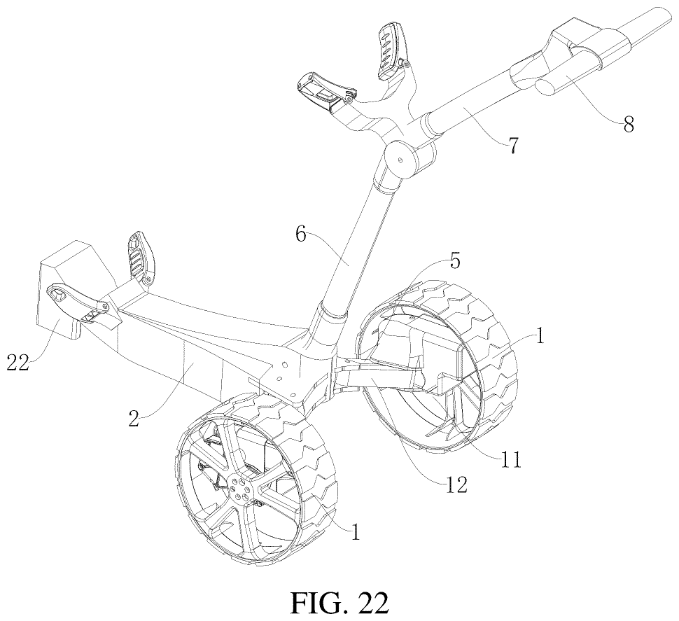

As shown in FIG. 22, on the basis of Example 6, the example further provides a foldable electric golf trolley. The electric golf trolley is a two-wheel golf trolley.

The two-wheel trolley is similar to the three-wheel trolley in structure, and differs in that a front end of the frame 2 of the two-wheel trolley is provided with supporting legs 22, so as to form triangular support with two rear wheels 1. Stability of the two-wheel trolley when placed is guaranteed.

In the example, the intra-wheel power system 11 is mounted in the two rear wheels 1.

The example uses the intra-wheel power system 11 disclosed in Example 6.

Reference may be made to the four-wheel trolley in Example 1 for the folding method and folding process of the two-wheel trolley disclosed in the example.

For the two-wheel trolley, the intra-wheel power system 11 may also be mounted in a single wheel.

In the four-wheel trolley, reference may be made to the structure of the three-wheel trolley in Example 8 for a connection manner between the rear wheel 1 without the intra-wheel power system 11 and the connecting rod 5.

In the three-wheel trolley, reference may be made to the structure of the four-wheel trolley in Example 1 for a method in which the intra-wheel power system 11 is mounted in the rear wheel 1.

In the two-wheel trolley, reference may be made to the structure of the three-wheel trolley in Example 8 for a connection manner between the rear wheel 1 without the intra-wheel power system 11 and the connecting rod 5.

When the two-wheel trolley in the electric golf trolley is in use, a balance can be manually controlled. The two-wheel trolley can be driven to walk by the intra-wheel power system 11.

The three-wheel trolley and the two-wheeled trolley are also applicable to the structure of the intra-wheel power system 1 and the supporting wheel 26 disclosed in Example 1, the locking method for folding and unfolding disclosed in Example 2, the intra-wheel power system 11 disclosed in Example 3, the structure of the supporting wheel 26 and a battery mounting method disclosed in Example 4 and Example 5, and the intra-wheel power system 11 disclosed in Example 6 and Example 7.

### Example 10

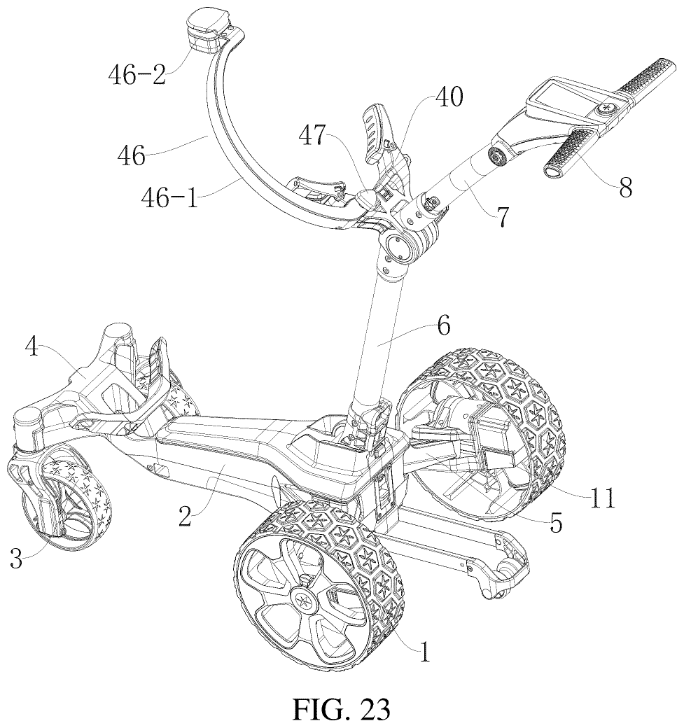

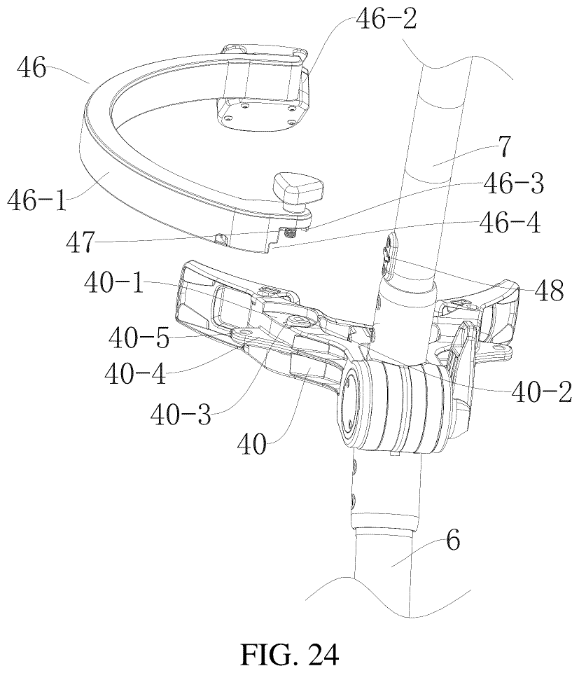

As shown in FIG. 23 to FIG. 24, on the basis of Example 5, the example further provides a foldable electric golf trolley, which has a same structure as that of Example 5 approximately. A difference lies in that:

A golf bag holder 40 of the electric golf trolley is provided with a detachable automatic following assembly 46.

The automatic following assembly 46 includes a following bracket 46-1 detachably mounted on the golf bag holder 40, and a laser radar 46-2 mounted on a front end of the automatic following bracket 46-1.

Specifically, the golf bag holder 40 is provided with a mounting table 40-1. The mounting table 40-1 is provided with a threaded hole 40-2. An end of the following bracket 46-1 is arranged on the mounting table 40-1. A fixing bolt 47 on the following bracket 46-1 passes through the following bracket 46-1 and is mounted in the threaded hole 40-2, so as to fix the following bracket 46-1.

Preferably, a positioning tooth groove 40-3 is arranged on a periphery of the threaded hole 40-2 on the mounting table 40-1. A positioning tooth 46-3 engaged with the positioning tooth groove 40-3 is arranged on the following bracket 46-1. When the following bracket 46-1 is fixed on the mounting table 40-1, the positioning tooth 46-3 is arranged in a corresponding positioning tooth groove 40-3, such that rotation of the following bracket 46-1 can be effectively avoided.

Preferably, an outer side of the mounting table 40-1 is provided with a sunken positioning step 40-4. The positioning step 40-4 is provided with an auxiliary positioning hole 40-4. The following bracket 46-1 is provided with a positioning groove 46-4 fit with the positioning step 40-4. An auxiliary positioning post (not shown) fit in the auxiliary positioning hole 40-5 is arranged in the positioning groove 46-4. Through the cooperation between the auxiliary positioning post and the auxiliary positioning hole 40-5, accurate positioning and mounting of the following bracket 46-1 can be implemented.

Preferably, the following bracket 46-1 is designed in an arc shape, which may conform to a shape of the golf bag more like the golf bag holder 40. Thus the entire electric golf trolley has a more beautiful shape.

An interface for being connected to an electric wire of the laser radar 46-2 is arranged on one side of the upper main tube towards the following bracket 46-1. A rubber plug 48 is mounted in the interface.

The electric wire of the laser radar 46-2 is arranged in the following bracket 46-1 and may extend out of one end of the following bracket 46-1 towards the golf bag holder 40. Thus the electric wire can be connected to the interface conveniently for supplying power to the laser radar 46-2 and implementing data communication between the laser radar 46-2 and an electric golf trolley control system.

Compared with a conventional method of mounting the laser radar 46-2 on the front wheel frame 4, an arrangement position and mounting method of the automatic following assembly 46 used in the present application have higher safety performance and more aesthetic appearance.

Before the electric golf trolley is folded, the automatic following assembly 46 needs to be removed.

The automatic following assembly 46 disclosed in the example can be applied to any one of the electric golf trolleys in the above Example 1 to Example 9.

In the present disclosure, aiming at the four-wheel golf trolley, the three-wheel golf trolley and the two-wheel golf trolley, an existing structure that a power system is arranged in the frame 2, the power system provided in the present disclosure is arranged in the wheel. Not only the structure of the frame 2 of the electric golf trolley is simplified, a size specification of the frame 2 is reduced, but also an unfoldable transmission shaft does not need to be arranged between the frame 2 and the wheel. Thus the electric golf trolley is completely folded. Further, an occupied space of the folded electric golf trolley is reduced. A folding structure is more compact, and the use is more convenient.

The above examples are only preferred examples of the present disclosure, and any method in which the wheels can be folded on two sides of the frame of the electric golf trolley should fall within the scope of protection of the present disclosure.

Inspired by the ideal examples of the present disclosure described above, various changes and modifications can be made by relevant personnel through the above description without departing from the technical idea of the present disclosure. The technical scope of the present disclosure is not limited to contents in the description, but must be determined according to the scope of the claims.

1. A foldable electric golf trolley, wherein when the electric golf trolley is folded, connecting rods on two sides of a frame of the electric golf trolley and wheels connected to the connecting rods are folded on the two sides of the frame.

2. The foldable electric golf trolley according to claim 1, wherein when a main tube assembly of the electric golf trolley is folded, the connecting rods on the two sides of the frame and the wheels connected to the connecting rods are synchronously driven to be folded on the two sides of the frame.

3. The foldable electric golf trolley according to claim 2, wherein a lower main tube of the main tube assembly rotates forwards to be folded on the frame, and synchronously drives the connecting rods to rotate forwards to be folded on the two sides of the frame and the wheels connected to the connecting rods to be folded on outer sides of the corresponding connecting rods.

4. The foldable electric golf trolley according to claim 3, wherein the lower main tube is linked with the connecting rods through gears.

5. The foldable electric golf trolley according to claim 4, wherein bevel gears I are arranged on two sides of a lower end of the lower main tube respectively, bevel gears II meshing with the bevel gears I are arranged at one ends of the connecting rods towards the frame, and the other ends of the connecting rods are hinged to wheel assemblies connected to the connecting rods.

6. The foldable electric golf trolley according to claim 5, wherein a lower locking wrench is arranged on a rear side of the frame, locking plates rotatably fit in the frame are arranged on an inner side of the lower locking wrench, outer ring surfaces of the bevel gears I are provided with two locking nicks fit with the locking plates and corresponding to an unfolded state and a folded state of the electric golf trolley respectively, arc-shaped through holes are correspondingly arranged on the two locking plates, a transverse locking pin is arranged in the two arc-shaped through holes, and a locking bayonet fit with the locking pin is arranged at the lower end of the lower main tube; and
the locking pin is located in the locking bayonet, to lock an unfolded state or a folded state of the lower main tube.

7. The foldable electric golf trolley according to claim 3, wherein the lower main tube is provided with a pullable locking assembly, and the frame is provided with a locking hole fit with the pullable locking assembly;
a locking rod of the pullable locking assembly extends into the corresponding locking hole, to lock the unfolded state of the lower main tube;
a twistable locking assembly is arranged on a golf bag holder at an upper end of the lower main tube, and a locking slot is arranged at a front end of the frame; and
a locking block of the twistable locking assembly is snapped into the locking slot, to lock the folded state of the lower main tube.

8. The foldable electric golf trolley according to claim 1, wherein at least one wheel of the electric golf trolley is internally provided with an intra-wheel power system for driving the electric golf trolley.

9. The foldable electric golf trolley according to claim 8, wherein the electric golf trolley is a four-wheel trolley or a three-wheel trolley.

10. The foldable electric golf trolley according to claim 8, wherein the electric golf trolley is a two-wheel golf trolley.

11. The foldable electric golf trolley according to claim 8, wherein the intra-wheel power system is mounted in at least one of wheels on two sides of a rear end of the frame; and
a box of the intra-wheel power system is hinged to the corresponding connecting rod.

12. The foldable electric golf trolley according to claim 8, wherein the intra-wheel power system is mounted in at least one of wheels at a front end of the frame; and
a box of the intra-wheel power system is connected to a corresponding front wheel frame.

13. The foldable electric golf trolley according to claim 8, wherein the intra-wheel power system comprises an electric motor and a worm wheel meshing with an output worm of the electric motor, and a spindle of the worm wheel is connected to a wheel hub corresponding to the intra-wheel power system; and
the electric motor is a brushless motor.

14. The foldable electric golf trolley according to claim 8, wherein the intra-wheel power system comprises an electric motor and a speed reduction assembly drivingly connected to the electric motor, and the speed reduction assembly is connected to an axle of a wheel corresponding to the intra-wheel power system; and
the speed reduction assembly comprises a worm wheel meshing with an output worm of the electric motor, and a gear set transmitting torque of the worm wheel to the axle of the corresponding wheel.

15. The foldable electric golf trolley according to claim 13, wherein the intra-wheel power system further comprises a parking assembly connected to an end of the output worm.

16. The foldable electric golf trolley according to claim 15, wherein the parking assembly comprises a friction plate connected to the output worm, and a brake pad capable of locking the friction plate.

17. The foldable electric golf trolley according to claim 16, wherein the parking assembly further comprises a brake stator, the brake pad is located on an inner side of the brake stator, the friction plate is mounted on one side of the brake stator towards the brake pad, and a coil is wound in the brake stator;
a return spring is mounted on one side of the brake stator towards the brake pad; and
a guide pin parallel to the output worm is mounted on the brake stator, and a guide nick fit with the guide pin is arranged on an outer ring surface of the brake pad.

18. The foldable electric golf trolley according to claim 1, wherein a battery mounting opening is arranged at a rear end of the frame of the electric golf trolley, and a battery of the electric golf trolley is mounted into a battery compartment in the frame from the battery mounting opening; and
a supporting wheel capable of horizontally retracting into a bottom of the frame is arranged on a rear side of the frame of the electric golf trolley.

19. The foldable electric golf trolley according to claim 18, wherein an ejection assembly capable of pushing the battery outwards from the battery mounting opening is arranged on a front side of the battery compartment.

20. The foldable electric golf trolley according to claim 1, wherein a golf bag holder of the electric golf trolley is provided with a detachable automatic following assembly.
